(19) United States
(12) Patent Application Publication
(10) Pub. No.: US 2015/0370199 A1
(43) Pub. Date: Dec. 24, 2015

(54) ELECTROPHOTOGRAPHIC BELT AND ELECTROPHOTOGRAPHIC IMAGE FORMING APPARATUS

(71) Applicant: CANON KABUSHIKI KAISHA, Tokyo (JP)

(72) Inventor: Hiroomi Kojima, Yokohama-shi (JP)

(21) Appl. No.: 14/737,801

(22) Filed: Jun. 12, 2015

(30) Foreign Application Priority Data
Jun. 23, 2014 (JP) 2014-128298

(51) Int. Cl. B32B 9/04

(52) U.S. Cl. CPC G03G 15/162

(57) ABSTRACT

Provided is an electrophotographic mono-layer belt. The electrophotographic mono-layer belt comprising:
a particle containing a polymer having a fluorinated hydrocarbon group; and
a silicone oil,
the particle and the silicone oil being in a thermoplastic matrix resin.

The particle has an average primary particle diameter of from 3 nm to 30 nm, and
the polymer comprises a branched polymer that has a functional group represented by the following formula [1] at a terminal of a side chain.

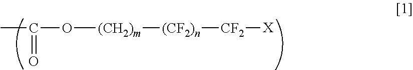

where X represents a hydrogen atom or a fluorine atom, m represents 1 or 2, and n represents an integer of from 0 to 5.

### BACKGROUND OF THE INVENTION

1. Field of the Invention

The present invention relates to an electrophotographic belt that may be used as, for example, an intermediate transfer belt, which is an intermediate transfer device for transferring a toner image from an image bearing member such as a photosensitive drum onto a recording medium such as paper in an image forming apparatus of an electrophotographic system, and to an electrophotographic image forming apparatus.

2. Description of the Related Art

In an electrophotographic image forming apparatus, as a transfer system for a toner image in formation of a color image, there is known an intermediate transfer system. In the intermediate transfer system, a toner image is transferred onto a recording medium by primarily transferring an unfixed toner image on an image bearing member onto an intermediate transfer belt first, and further, secondarily transferring the unfixed toner image from the intermediate transfer belt onto the recording medium.

Regarding the intermediate transfer belt to be used in this system, technological development has been made in various ways in order to obtain a high-quality electrophotographic image. In Japanese Patent Application Laid-Open No. 2003-316169, there is a disclosure that a coating layer of a curable acrylic resin or the like is formed on a surface of a belt base material in order to improve belt surface characteristics, such as toner releasability and surface smoothness, of a surface of the intermediate transfer belt, and to improve abrasion characteristics of the surface of the belt.

In addition, in view of problems of the coating layer such as: a cost increase due to increases in amount of use of materials for the belt and in number of manufacturing steps; and peeling of the coating layer due to the lapse of time, there has also been proposed an intermediate transfer mono-layer belt construction in which no coating layer is formed. Further, in Japanese Patent Application Laid-Open No. 2006-079016, with a view to improving surface characteristics of the intermediate transfer mono-layer belt construction, there is disclosed a semiconductive belt obtained by dispersing fluorine-containing resin powder having an average particle diameter of 1 μm or less (the material described in Examples is fluorine resin powder having an average particle diameter of 0.2 μm) in a thermosetting elastomer composition, followed by curing.

The present invention is directed to the provision of an electrophotographic belt that, as compared to the related-art mono-layer intermediate transfer belt, is extremely excellent in surface smoothness and can maintain high image quality not only at an initial stage but also after repeated use.

The present invention is also directed to the provision of an electrophotographic image forming apparatus capable of stably forming a high-quality electrophotographic image.

### SUMMARY OF THE INVENTION

According to one embodiment of the present invention, there is provided an electrophotographic mono-layer belt, including: a particle containing a polymer having a fluorinated hydrocarbon group; and a silicone oil, the particle and the silicone oil being in a thermoplastic matrix resin, the particle has an average primary diameter of from 3 nm to 30 nm, and the polymer comprises a branched polymer that has a functional group represented by the following formula [1] at a terminal of a side chain, and when a thickness of the electrophotographic mono-layer belt is represented by T, in a cross-section of the electrophotographic mono-layer belt in a thickness direction, a presence amount of silicone oil-derived silicon atom at a surface of the belt satisfies a relationship of (presence amount of a silicon atom at surface of belt)>(presence amount of a silicon atom at 1T/2-thickness section); and the particle is dispersed in the belt in the thickness direction.

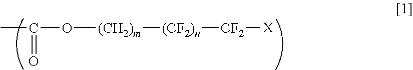

(In the formula, X represents a hydrogen atom or a fluorine atom, m represents 1 or 2, and n represents an integer of from 0 to 5.)

In addition, according to another embodiment of the present invention, there is provided an electrophotographic image forming apparatus configured to form an electrophotographic image by: primarily transferring a toner image borne on an electrostatic latent image bearing member onto an intermediate transfer device; then secondarily transferring the toner image from the intermediate transfer device onto a recording medium; and fixing the toner image transferred onto the recording medium, in which the intermediate transfer device is the above-mentioned electrophotographic mono-layer belt.

Further features of the present invention will become apparent from the following description of exemplary embodiments with reference to the attached drawings.

### BRIEF DESCRIPTION OF THE DRAWINGS

FIG. 1 is a schematic view of an electrophotographic image forming apparatus according to the present invention.

FIG. 2 is a schematic view of an example of an injection molding apparatus to be used in the present invention.

FIG. 3 is a schematic view of an example of a blow molding apparatus to be used in the present invention.

FIG. 4 is an explanatory view of an electrophotographic belt of the present invention.

FIG. 5 is an explanatory view in which a cross-section (thickness section) of the electrophotographic belt of the present invention is divided into quarters.

### DESCRIPTION OF THE EMBODIMENTS

Preferred embodiments of the present invention will now be described in detail in accordance with the accompanying drawings.

The inventors of the present invention conducted investigations on the electrophotographic belt according to Japanese Patent Application Laid-Open No. 2006-079016. As a result, when a lubricating filler having an average particle diameter of 0.2 μm (200 nm) was incorporated, the surface of the electrophotographic belt was non-uniformly roughened in some cases depending on the state in which the lubricating filler was dispersed in a thermoplastic elastomer. Such electrophotographic belt affects the efficiency of toner image transfer (primary transfer and/or secondary transfer), and consequently, also affects the quality of an electrophotographic image in some cases.

Further, along with an increase in lifetime of an electrophotographic image forming apparatus, a change in surface condition of an intermediate transfer belt due to the lapse of time has been emerging as a problem. That is, owing to the use of the intermediate transfer belt over a long period of time, its surface is progressively abraded to change the releasability of a toner image from the surface of the intermediate transfer belt as compared to an initial stage, resulting in a change in image quality as compared to the initial stage in some cases.

In view of the foregoing, in order to obtain an electrophotographic mono-layer belt construction capable of realizing higher image quality than that of the related art, the inventors of the present invention produced an electrophotographic mono-layer belt by adding, as a lubricant, a particle having an extremely small average particle diameter and containing a polymer having a fluorinated hydrocarbon group (hereinafter sometimes referred to as “polymer particles”) into a base material matrix resin, and conducted further investigations.

The polymer particle having an extremely small average particle diameter was used for the following reason. The particles having a smaller average particle diameter has a relatively larger specific surface area. Accordingly, it is considered that even a small amount of the particle can improve lubricity, and further, the particle does not significantly impair the smoothness of the surface of the electrophotographic belt as compared to the surface smoothness of the base material matrix resin alone.

The smoothness of the surface of the electrophotographic belt significantly affects image quality, and hence there is a demand for higher smoothness.

Specifically, a particle having an average particle diameter of from 3 nm to 30 nm and containing a branched polymer having a fluorinated hydrocarbon group was used as the polymer particle, and the particle was added into the thermoplastic matrix resin, followed by a thermally melting and kneading step and a heat treatment step. Thus, an electrophotographic belt was produced.

As a result, its surface was extremely smooth as compared to an electrophotographic mono-layer belt having added thereto polytetrafluoroethylene having an average particle diameter of about 200 nm.

In addition, an electrophotographic image was produced using, as an intermediate transfer belt, the electrophotographic belt containing the polymer particles having an average particle diameter of from 3 nm to 30 nm, and the resultant electrophotographic image was confirmed to be of high quality and be improved in toner releasability as well. The result suggests that as the average particle diameter of the lubricant to be added becomes smaller, the toner releasability can be improved more.

However, through further investigations, the inventors of the present invention confirmed the following. When the electrophotographic belt having added thereto the particle having an average particle diameter of from 3 nm to 30 nm and containing a branched polymer having a fluorinated hydrocarbon group described above was mounted as an intermediate transfer belt onto a color image forming apparatus and subjected to repeated use, along with the progress of wear of the surface of the belt, the toner releasability was remarkably reduced as compared to the initial stage.

In this phenomenon, the toner releasability was reduced probably because the surface of the belt was worn away to impair the smoothness. However, no large difference was found between surface roughnesses at the initial stage and after the repeated use.

On the other hand, when the above-mentioned electrophotographic belt whose surface had been worn away through repeated use was subjected to quantitative analysis for the fluorine element at the surface, almost no fluorine component was able to be found. This is because the added particle containing a branched polymer having a fluorinated hydrocarbon group had an extremely small average particle diameter of from 3 nm to 30 nm, and hence easily moved in the thermoplastic matrix resin, consequently moving to the vicinity of the surface owing to the heat treatment step at the time of the manufacture of the belt, and the lapse of time after the manufacture.

In general, a fine particle having a small particle diameter and low surface free energy easily migrates in the thermoplastic matrix resin toward the vicinity of the surface, and particularly when the viscosity of the thermoplastic matrix resin is reduced through heating, the migration is promoted. When the particle containing a branched polymer having a fluorinated hydrocarbon group is localized to the vicinity of the surface of the electrophotographic belt, the number of particle containing a branched polymer having a fluorinated hydrocarbon group is relatively decreased at a section deep from the surface of the electrophotographic belt. Accordingly, when the surface of the electrophotographic belt is worn away through repeated use, the toner releasability may be reduced.

There has been a strong demand for a color image forming apparatus having high durability in recent years. Even if the image quality at an initial stage is extremely good, the image quality may be reduced during repeated use (endurance). Therefore, the inventors of the present invention have come to recognize that in the electrophotographic belt including a resin layer in which the particle having an average particle diameter of from 3 nm to 30 nm and containing a branched polymer having a fluorinated hydrocarbon group is added into the thermoplastic matrix resin, there is a need to develop a technology of suppressing the localization of the particles each containing a branched polymer having a fluorinated hydrocarbon group to the vicinity of the surface, thereby enabling the toner releasability to be maintained even when the surface of the belt is worn away through repeated use.

Hereinafter, preferred embodiments of the present invention are described in detail.

An elecrophotographic belt according to the present invention is an electrophotographic mono-layer belt, including: thermoplastic resin, a particle containing a polymer having a fluorinated hydrocarbon group, and a silicone oil. The particle and the silicone oil are in the thermoplastic matrix resin. In addition, the particle containing a polymer having a fluorinated hydrocarbon group is a particle containing a branched polymer that has a functional group represented by the following formula [1] at a terminal of a side chain, and the particle having an average primary particle diameter of from 3 nm to 30 nm. In addition, when a thickness of the electrophotographic mono-layer belt is represented by T, in a cross-section of the electrophotographic mono-layer belt in a thickness direction, a presence amount of a silicon atom derived from the silicone oil at a surface of the belt satisfies a relationship of (presence amount of a silicon atom at surface of belt)>(presence amount of a silicon atom at 1T/2-thickness section), and the particle containing a polymer having a fluorinated hydrocarbon group is dispersed in the belt in the thickness direction.

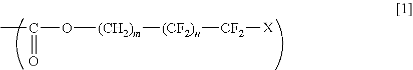

(In the formula, X represents a hydrogen atom or a fluorine atom, m represents 1 or 2, and n represents an integer of from 0 to 5.)

It should be noted that in the present invention, that “the polymer particles are dispersed in a cross-section of the electrophotographic belt in the thickness direction” refers to the case where when the thickness of the belt is represented by “T”, and when the numbers of “polymer particles each having a fluorinated hydrocarbon group” at three sites in the cross-section of the belt in the thickness direction, i.e., the outermost surface, a section at a depth of 1T/4 from the outermost surface, and a section at a depth of 2T/4 from the outermost surface are calculated based on an image obtained by observation using a transmission electron microscope at a magnification of 100,000, the number of particles at the outermost surface is 0.7 or more times and 1.5 or less times as large as the number of particles at the 1T/4 section, and is 0.7 or more times and 1.5 or less times as large as the number of particles at the 2T/4 section.

The electrophotographic belt according to the present invention contains a resin composition formed of: a thermoplastic resin as a thermoplastic matrix resin; a particle having an average primary particle diameter of from 3 nm to 30 nm and containing a branched polymer having a fluorinated hydrocarbon group; and a silicone oil. Now, these materials are described.

<Thermoplastic Resin>

The thermoplastic resin that may be used in the present invention is not particularly limited. However, when the belt is intended to be used for an electrophotographic apparatus, a thermoplastic polyester resin is preferred as the thermoplastic resin, and the following resins are also preferred: polypropylene, polyethylene (high density, middle density, low density, or linear low density polyethylene), a propylene ethylene block or random copolymer, a rubber or latex component, ethylene/propylene copolymer rubber, styrene/butadiene rubber, a styrene/butadiene/styrene block copolymer or a hydrogenated derivative thereof, polybutadiene, polyisobutylene, polyamide, polyamide imide, polyacetal, polyarylate, polycarbonate, polyphenylene ether, modified polyphenylene ether, polyimide, liquid crystalline polyester, polyethylene terephthalate, polyethylene naphthalate, polysulfone, polyether sulfone, polyphenylene sulfide, polybisamide triazole, polybutylene terephthalate, polyether imide, polyether ether ketone, an acrylic polymer, polyvinylidene fluoride, polyvinyl fluoride, an ethylene tetrafluoroethylene copolymer, a chlorotrifluoroethylene copolymer, hexafluoropropylene, a perfluoroalkyl vinyl ether copolymer, an acrylic acid alkyl ester copolymer, a polyester ester copolymer, a polyether ester copolymer, a polyether amide copolymer, and a polyurethane copolymer. One kind of those resins may be used alone, or two or more kinds thereof may be used in combination. In addition, in consideration of durability, a plastic classified as an engineering plastic or a super engineering plastic is preferred as the thermoplastic resin. Specifically, polyether ether ketone, polyethylene sulfide, polycarbonate, polyvinylidene fluoride, polyethylene terephthalate, or polyethylene naphthalate is more preferred.

The content of the thermoplastic resin is set to preferably 50.0 mass % or more, particularly preferably 60.0 mass % or more, more preferably 70.0 mass % or more with respect to the total mass of the resin composition. When the content is 50.0 mass % or more, a reduction in durability of the electrophotographic belt can be suppressed. In addition, the content of the thermoplastic resin is set to preferably 99.2 mass % or less, more preferably 90.0 mass % or less with respect to the total mass of the resin composition.

<Particle Having Average Primary Particle Diameter of from 3 nm to 30 nm and Having Fluorinated Hydrocarbon Group>

In the present invention, the particle having an average primary particle diameter of from 3 nm to 30 nm and containing a branched polymer having a fluorinated hydrocarbon group is used as the particle containing a polymer having a fluorinated hydrocarbon group.

An example of the branched polymer having a fluorinated hydrocarbon group is one having a main chain of a branched structure typified by a star polymer, a dendrimer, or a hyperbranched polymer, and having a side chain terminally modified with the functional group of the formula [1], which contains a fluorinated hydrocarbon group. The main chain of the branched polymer is not linear but is branched, and its molecules are hardly entangled and hardly aggregated with each other. Accordingly, even a branched polymer having an extremely small particle diameter of several nanometers is commercially available. Further, the branched polymer has many functional terminal groups at a molecular surface, and hence the effective expression of a modified function of interest is one of its features.

The content of the branched polymer having a fluorinated hydrocarbon group is preferably set to 0.3 mass % or more with respect to the total mass of the resin composition from the viewpoint of toner releasability. In addition, the content is preferably set to 5.0 mass % or less from the viewpoints of suppressing the degradation of belt moldability or the lack of strength of the belt due to a reduction in viscosity of the resin composition, and reducing material cost.

In the present invention, the polymer particle is dispersed in the electrophotographic belt in the thickness direction.

<Silicone Oil>

The silicone oil has a linear structure whose main chain is formed of a siloxane bond, and the oil has a molecular weight of generally 200,000 or less, and is a liquid at normal temperature. The silicone oil is not particularly limited as long as it exhibits flowability at the molding temperature of the electrophotographic belt. For example, the following silicone oil is used: a dimethyl silicone oil, a methyl hydrogen silicone oil, a methylphenylsilicone oil, an amino-modified silicone oil, an alkyl-modified silicone oil, a fluorine-modified silicone oil, a polyether-modified silicone oil, an alcohol-modified silicone oil, an epoxy-modified silicone oil, an alkoxy-modified silicone oil, or a carboxy-modified silicone oil. One kind of those oils may be used alone, or two or more kinds thereof may be used in combination.

It is known that the silicone oil undergoes little change in viscosity in a temperature-dependent manner, and is usually a liquid, and hence when blended in a thermoplastic matrix resin, bleeds out to the surface of the belt owing to a heat treatment step during belt molding or the lapse of time. When the blending amount of the silicone oil is an appropriate one, effective modification of the surface of the belt such as the impartment of lubricity can be achieved. However, excessive bleedout may reduce a lubricating effect or may cause the contamination of other members.

In the present invention, the silicone oil added to the electrophotographic belt is a liquid, and hence is considered to extremely easily move in the thermoplastic matrix resin and easily migrate to the vicinity of the surface as compared to the branched polymer having a fluorinated hydrocarbon group, which is a solid. Therefore, it is presumed that the silicone oil migrates to the vicinity of the surface of the belt before the branched polymer having a fluorinated hydrocarbon group at the time of heat treatment in belt molding, to reduce (and/or stabilize) the surface energy of the surface of the belt, thereby suppressing the migration of the branched polymer having a fluorinated hydrocarbon group to the surface. As a result, the branched polymer having a fluorinated hydrocarbon group can maintain its homogeneous dispersion in the belt.

The content of the silicone oil is preferably set to 0.5 mass % or more with respect to the total mass of the resin composition as an amount that allows the silicone oil to migrate to the vicinity of the surface of the belt to reduce the surface energy. In addition, the content is preferably set to 5.0 mass % or less from the viewpoint of suppressing the excessive bleedout of the silicone oil to the surface of the belt, which may cause the contamination of other members with which the surface is brought into contact, or the degradation of the toner releasability.

In the present invention, when the thickness of the electrophotographic belt is represented by T, in a cross-section of the electrophotographic belt in the thickness direction, the presence amount of silicone oil-derived silicon atoms at the surface of the belt satisfies a relationship of (presence amount of silicon atoms at surface of belt)>(presence amount of silicon atoms at 1T/2-thickness section). In addition, the presence amount of the silicone oil-derived silicon atoms at the surface of the belt more preferably satisfies a relationship of (presence amount of silicon atoms at surface of belt)≧1.4×(presence amount of silicon atoms at 1T/2-thickness section). This is because it has been experimentally confirmed that when the ratio is 1.4 or more times, a difference in surface energy between the inside of the belt and the surface of the belt becomes relatively large, and thus the migration of the branched polymer having a fluorinated hydrocarbon group present inside the belt to the surface of the belt is more likely to be suppressed.

In the present invention, as illustrated in FIG. 5, the thickness sections of the electrophotographic belt are defined as 1T/4, 2T/4 (=1T/2), and 3T/4 in a belt cross-section (thickness T) from the surface (toner image bearing surface) of the belt. In FIG. 5, a belt outer surface is denoted by reference numeral 113, a belt inner surface is denoted by reference numeral 114, a thermoplastic matrix resin is denoted by reference numeral 115, and a polymer particle having a fluorinated hydrocarbon group is denoted by reference numeral 116.

<Additive>

As any other component for forming the electrophotographic belt in the present invention, there may be given, for example, ion conductive agents (such as a polymer ionic conductive agent and a surfactant), an electroconductive polymer, antioxidants (such as a hindered phenol-based antioxidant, and phosphorus and sulfur-based antioxidants), a UV absorber, an organic pigment, an inorganic pigment, a pH regulator, a crosslinking agent, a compatibilizer, a coupling agent, a lubricant, insulating fillers (such as zinc oxide, barium sulfate, calcium sulfate, barium titanate, potassium titanate, strontium titanate, titanium oxide, magnesium oxide, magnesium hydroxide, aluminum hydroxide, talc, mica, clay, kaolin, hydrotalcite, silica, alumina, ferrite, calcium carbonate, barium carbonate, nickel carbonate, glass powder, quartz powder, glass fibers, alumina fibers, potassium titanate fibers, and a fine particle of a thermosetting resin), electroconductive fillers (such as carbon black, carbon fibers, electroconductive titanium oxide, electroconductive tin oxide, and electroconductive mica), and an ionic liquid. One kind of those components may be used alone, or two or more kinds thereof may be used in combination.

<Electrophotographic Belt>

The electrophotographic belt according to the present invention contains the above-mentioned thermoplastic resin composition. Specifically, for example, an electrophotographic belt having a seamless shape can be obtained by pelletizing the thermoplastic resin composition and molding the pellets by a known molding method such as a continuous melt extrusion molding method, an injection molding process, a stretch blow molding process, or an inflation molding method. The molding method for the electrophotographic belt is particularly preferably a continuous melt extrusion molding method or a stretch blow molding process. Examples of the continuous melt extrusion molding method include: a downwardly extruding internal cooling mandrel system that allows precise control of the inner diameter of an extruded tube; and a vacuum sizing system. A production method for the electrophotographic belt based on the stretch blow molding process includes the steps of: molding the thermoplastic resin composition into a preform; heating the preform; mounting the preform after the heating into a mold for seamless belt molding, followed by the injection of a gas into the mold for molding to perform stretch molding; and cutting a stretch molded article obtained by the stretch molding to obtain a seamless belt.

The thickness of the electrophotographic belt is preferably 10 μm or more and 500 μm or less, particularly preferably 30 μm or more and 150 μm or less. In addition, besides its direct use as a belt, the electrophotographic belt of the present invention may be used, for example, to wrap or cover a drum or a roll.

The electrophotographic belt preferably has a tensile modulus of 500 MPa or more and 5,000 MPa or less. When the tensile modulus is less than 500 MPa, the belt is slowly elongated through repeated use, which may cause an image failure such as color misregistration. In addition, when the tensile modulus is 5,000 MPa or more, the belt may be ruptured from a fissure such as a crack at an end portion owing to bending fatigue.

Further, regarding the volume resistance of the electrophotographic belt, which significantly affects image quality, the electrophotographic belt preferably has a specific volume resistivity of 1×10² Ωcm or more and 1×10¹⁴ Ωcm or less. When the specific volume resistivity is 1×10² Ωcm or more, the resistance can be prevented from becoming remarkably low, a transfer electric field can be easily obtained, and the occurrence of a void or roughness in an image can be excellently prevented.

When the specific volume resistivity is 1×10¹⁴ Ωcm or less, an increase in transfer voltage can be excellently prevented, and an increase in size of a power source and an increase in cost can be excellently prevented. It should be noted that even when the specific volume resistivity falls outside the above-mentioned range, transfer can be performed in some cases depending on a transfer process, and hence the specific volume resistivity is not necessarily limited to the above-mentioned range.

<Image Forming Apparatus>

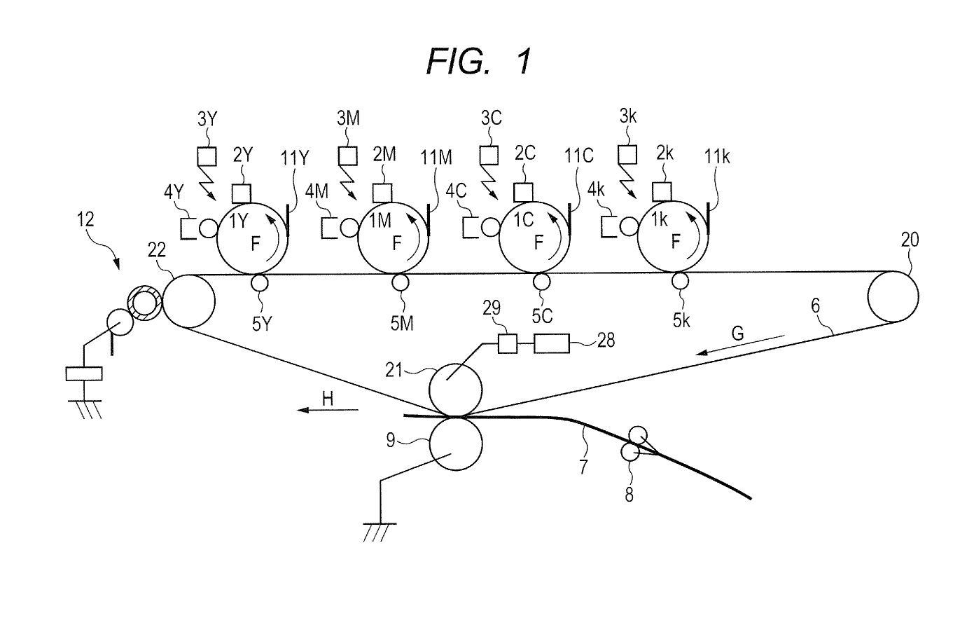

An electrophotographic image forming apparatus for forming a full-color image (hereinafter sometimes simply referred to as “image forming apparatus” using the electrophotographic belt of the present invention as an intermediate transfer belt is described with reference to FIG. 1. The image forming apparatus has the so-called tandem-type configuration in which image forming stations for a plurality of colors are disposed by being arranged in the rotation direction of the electrophotographic belt of the present invention. It should be noted that, in the following description, reference symbols for members for yellow, magenta, cyan, and black colors are affixed with Y, M, C, and k, respectively, but the affixes are sometimes omitted for like members.

Reference symbols 1Y, 1M, 1C, and 1k in FIG. 1 denote drum-shaped electrostatic latent image bearing members (hereinafter sometimes referred to as “photosensitive drums”), and around the photosensitive drums 1, there are disposed charging apparatus 2Y, 2M, 2C, 2k, exposing apparatus 3Y, 3M, 3C, 3k, developing apparatus 4Y, 4M, 4C, 4k, and an intermediate transfer belt (intermediate transfer device) 6. The photosensitive drums are driven to rotate in the direction indicated by an arrow F at a predetermined circumferential speed (process speed). The charging apparatus 2 charge the circumferential surfaces of the photosensitive drums 1 to a predetermined polarity and electric potential (primary charging). Laser beam scanners serving as the exposing apparatus 3 output laser light that is on/off-modulated according to image information inputted from an external device (not shown) such as an image scanner or a computer, to thereby subject the surfaces on the photosensitive drums that have been subjected to the charging treatment to scanning exposure. The scanning exposure results in the formation of electrostatic latent images according to image information of interest on the surfaces of the photosensitive drums 1.

The developing apparatus 4Y, 4M, 4C, 4k contain toners containing color components for yellow (Y), magenta (M), cyan (C), and black (k), respectively. In addition, the developing apparatus 4 to be used are selected based on the image information, a developer (toner) is developed on the surfaces of the photosensitive drums 1, and the electrostatic latent images are visualized as toner images. In this embodiment, as just described, a reversal development system in which development is performed by causing toner to adhere to the exposed portions of the electrostatic latent images is used. In addition, such charging apparatus, exposing apparatus, and developing apparatus constitute an image forming unit.

In addition, the intermediate transfer belt 6 is an endless electrophotographic belt according to the present invention, is arranged so as to abut on the surfaces of the photosensitive drums 1, and is stretched by a plurality of stretching rollers 20, 21, 22. In addition, the intermediate transfer belt 6 is configured to rotate in the direction indicated by an arrow G. In this embodiment, the stretching roller 20 is a tension roller configured to control the tension of the intermediate transfer belt 6 at a constant level, the stretching roller 22 is a driving roller for the intermediate transfer belt 6, and the stretching roller 21 is an opposing roller for secondary transfer. In addition, at primary transfer positions opposed to the photosensitive drums 1 across the intermediate transfer belt 6, primary transfer rollers 5Y, 5M, 5C, 5k are disposed, respectively.

The unfixed toner images of the respective colors respectively formed on the photosensitive drums 1 are subjected to electrostatic primary transfer onto the intermediate transfer belt 6 sequentially through the application of a primary transfer bias, which has a positive polarity opposite to the polarity of the charge of the toner, to the primary transfer roller 5 with a constant voltage source or a constant current source. Thus, a full-color image in which the unfixed toner images of the four colors are superimposed is obtained on the intermediate transfer belt 6. The intermediate transfer belt 6 rotates while bearing the toner image transferred from the photosensitive drums 1 as just described. For every rotation of the photosensitive drums 1 after the primary transfer, the surfaces of the photosensitive drums 1 are cleaned of transfer residual toner with a cleaning apparatus 11 to be repeatedly used in the image formation process.

In addition, at a secondary transfer position in the intermediate transfer belt 6, which faces a conveyance path for a recording medium 7, a secondary transfer roller (transfer member) 9 is disposed so as be brought into pressure contact with the toner image bearing surface side of the intermediate transfer belt 6. In addition, on the back surface side of the intermediate transfer belt 6 with respect to the secondary transfer position, the opposing roller 21 is arranged, which serves as an opposite electrode for the secondary transfer roller 9 and to which a bias is applied. At the time of the transfer of the toner image on the intermediate transfer belt 6 onto the recording medium 7, a bias having the same polarity as that of the toner is applied to the opposing roller 21 with a transfer bias applying unit 28, and for example, a bias of from −1,000 V to −3,000 V is applied to cause a current of from −10 μA to −50 μA to flow. The transfer voltage at this time is detected with a high transfer voltage detecting unit 29. Further, on the downstream side with respect to the secondary transfer position, there is arranged a cleaning apparatus (belt cleaner) 12 for removing toner remaining on the intermediate transfer belt 6 after the secondary transfer.

The recording medium 7 is conveyed in the direction indicated by an arrow H via a conveyance guide 8, and then introduced to the secondary transfer position. The introduced recording medium 7 is conveyed while being sandwiched at the secondary transfer position, and during the conveyance, the opposing roller 21 for the secondary transfer roller 9 is supplied with a constant voltage bias (transfer bias) controlled to a predetermined value from the secondary transfer bias applying unit 28. Through the application of the transfer bias having the same polarity as that of the toner to the opposing roller 21, the full-color image (toner image) formed of the four colors superimposed on the intermediate transfer belt 6 is transferred at once onto the recording medium 7 at the transfer site. Thus, the full-color unfixed toner image is formed on the recording medium. The recording medium 7 onto which the toner image has been transferred is introduced into a fixing unit (not shown), and the unfixed toner image is heated to be fixed to the recording medium.

According to one embodiment of the present invention, there can be obtained a mono-layer intermediate transfer belt that is extremely excellent in surface smoothness and has high toner releasability even after repeated use. In addition, according to another embodiment of the present invention, there can be obtained an electrophotographic image forming apparatus capable of stably forming a high-quality electrophotographic image.

### EXAMPLES

The present invention is specifically described below by way of Examples and Comparative Examples. However, the present invention is not limited thereto. It should be noted that, in Examples and Comparative Examples, intermediate transfer belts were produced, and analysis and physical property measurement used in Examples and Comparative Examples were performed as described below.

### (Measurement Methods and Evaluation Methods for Characteristic Values)

Measurement methods and evaluation methods for characteristic values of intermediate transfer belts produced in Examples and Comparative Examples are as described below.

(1) Toner Releasability

Toner releasability was evaluated in terms of secondary transfer efficiency (%). The secondary transfer efficiency was calculated from a toner amount F (g) borne on the surface of an intermediate transfer belt as a result of primary transfer from a photosensitive drum, and a residual toner amount S (g) remaining on the surface of the intermediate transfer belt after secondary transfer onto a recording medium. Specifically, the secondary transfer efficiency is represented by the following equation [2].

Secondary transfer efficiency(%)=(1−S/F)×100 [2]

In actual evaluation, an intermediate transfer belt was mounted onto the transfer unit of a tandem-type full-color electrophotographic apparatus of an intermediate transfer system having an apparatus structure as illustrated in FIG. 1 (trade name: LBP-7700C, manufactured by Canon Inc.), and a solid image of cyan and magenta was printed on a recording medium. It should be noted that the recording medium used was rough-surfaced paper having an arithmetic average roughness (Ra) of 4 μm and a ten-point average roughness (Rz) of 15 μm that had been left to stand under an environment having a temperature of 23° C. and a relative humidity of 45% for 1 day. An image printed on a 10th sheet was defined as an image at an initial stage, and an image printed on a 100,000th sheet was defined as an image after repeated use. The image at the initial stage and the image after repeated use were used to evaluate the secondary transfer efficiency.

(2) Surface Roughness

The surface roughness of a belt was evaluated with a surface roughness measuring instrument (KOSAKA-SE3500 manufactured by Nihonkai Keisoku Tokki Co., Ltd.) by scanning the surface of the belt with a measurement terminal in the width direction. Measurement conditions are shown below. The evaluation was performed using a ten-point average roughness (Rzjis).

Measurement sample size: 30 mm×30 mm

Measurement interval: 4.0 mm

Terminal scanning speed: 0.1 mm/sec

In addition, an intermediate transfer belt, which was produced without blending particles 1 each containing a polymer having a fluorinated hydrocarbon group, and a silicone oil 1 in Example 1 to be described later, was used as a standard belt, and its surface roughness Rzjis was measured in advance to be 0.23 μm.

(3) Evaluation of Average Primary Particle Diameter of Particles Each Containing Polymer Having Fluorinated Hydrocarbon Group

The average primary particle diameter of particles each containing a polymer having a fluorinated hydrocarbon group was evaluated by the following method.

First, a produced intermediate transfer belt was divided into quarters in the axis direction, and part of each of the resultant cross-sections was further cut out with a microtome or the like. Four sites in the belt thickness (=T) direction illustrated in FIG. 5 (the outermost surface (toner image carrier surface), 1T/4, 2T/4 (=1T/2), and 3T/4 with reference to the belt outer surface) were observed with a transmission electron microscope (transmission electron microscopy: TEM) at a magnification of 200,000 and photographed.

In addition, simultaneously, energy dispersive X-ray spectroscopy (EDX) was used to perform elemental analysis for particles seen in the observed photograph to identify particles each containing a polymer having a fluorinated hydrocarbon group. Further, 100 particles each containing a polymer having a fluorinated hydrocarbon group were selected from the resultant photograph, and the maximum length (nm) in the belt thickness direction and the maximum length (nm) in a direction orthogonal to the belt thickness direction were measured, and a value obtained by dividing the sum of these values by 2 was adopted as a primary particle diameter. Then, the arithmetic average of the primary particle diameters of the selected 100 particles each containing a polymer having a fluorinated hydrocarbon group was defined as the average primary particle diameter of the particles each containing a polymer having a fluorinated hydrocarbon group in the present invention.

(4) Evaluation of Dispersibility of Particles Each Containing Polymer Having Fluorinated Hydrocarbon Group in Belt Thickness Direction

A cross-section of the belt in the thickness direction was cut out by the same method as in the section (3). Three sites in the thickness direction (the outermost surface, 1T/4, and 2T/4) were each observed using a transmission electron microscope at a magnification of 100,000, and the dispersibility of the polymer particles was evaluated based on the resultant images. Evaluation criteria were set as described below.

A: The number of particles at the outermost surface is 0.7 or more times and 1.5 or less times as large as the number of particles at the 1T/4 section, and 0.7 or more times and 1.5 or less times as large as the number of particles at the 2T/4 section.
B: The number of particles at the outermost surface is 0.2 or more times and 0.5 or less times, or 2 or more times and less than 5 times as large as the number of particles at the 1T/4 section or the 2T/4 section.
C: The number of particles at the outermost surface is less than 0.2 times or 5 or more times as large as the number of particles at the 1T/4 section or the 2T/4 section.

(5) Presence Ratio of Silicone Oil-Derived Silicon Atoms

The presence amount of silicone oil-derived silicon atoms was measured using a time of flight secondary ion mass spectrometer (time of flight secondary ion mass spectrometry). The surface of an unused intermediate transfer belt at an arbitrary portion was cut into a size of 80 mm×80 mm, and subjected to elemental analysis for silicon atoms and to evaluation of the maximum peak intensity (P1). Subsequently, the same belt was cut or subjected to surface grinding so as to have a thickness of 1T/2, and similarly subjected to elemental analysis for silicon atoms at a section at a thickness of 1T/2, and to evaluation of a peak intensity (P2) at the same molecular weight/number of charges (M/Z) as that of the detection axis of P1. The presence amount ratio of silicone oil-derived silicon atoms was defined by regarding the presence amount ratio of silicone oil-derived silicon atoms between the surface of the belt and the 1T/2 section as P1/P2 (times).

(Materials for Resin Compositions for Belts Used in Examples and Comparative Examples)

Tables 1 to 4 below show materials for resin compositions used in Examples and Comparative Examples to be described later. It should be noted that Tables 5 and 7 show blends of materials for the examples.

TABLE 1
Thermoplastic Resin

| | |
|---|---|
| Thermoplastic | Polyethylene naphthalate |
| resin 1 | (trade name: TN-8050SC, |
| | manufactured by |
| | Teijin Chemicals Ltd.) |
| | Tm: 260° C.; |
| Thermoplastic | Polyethylene terephthalate |
| resin 2 | (trade name: TRN-8550FF, |
| | manufactured by |
| | Teijin Chemicals Ltd.) |
| | Tm: 252° C.; |

TABLE 2
Particle Containing Polymer Having
Fluorinated Hydrocarbon Group

| | |
|---|---|
| Polymer | Fluorinated hydrocarbon group- |
| particles 1 | containing branched polymer |
| | (trade name: FA-200, manufactured by |
| | Nissan Chemical Industries, Ltd.) |
| Polymer | Fluorinated hydrocarbon group- |
| particles 2 | containing branched polymer |
| | (trade name: FA-E-50, manufactured by |
| | Nissan Chemical Industries, Ltd.) |
| Polymer | Fluorinated hydrocarbon group- |
| particles 3 | containing branched polymer |
| | (trade name: Ruburon L-2, manufactured |
| | by Daikin Industries, Ltd) |

TABLE 3
Silicone Oil

| | |
|---|---|
| Silicone oil 1 | Dimethyl silicone oil |
| | (trade name: KF-96-100cs, manufactured |
| | by Shin-Etsu Chemical Co. , Ltd.) |
| Silicone oil 2 | Dimethyl silicone oil |
| | (trade name: KF-96-1000cs, manufactured |
| | by Shin-Etsu Chemical Co. , Ltd.) |
| Silicone oil 3 | Dimethyl silicone oil |
| | (trade name: KF-96-10000cs, manufactured |
| | by Shin-Etsu Chemical Co. , Ltd.) |
| Silicone oil 4 | Polyether-modified silicone oil |
| | (trade name: KF-615A, manufactured by |
| | Shin-Etsu Chemical Co. , Ltd.) |

TABLE 4
Additive

| | |
|---|---|
| Additive 1 | Polyether ester amide |
| | (trade name: IRGASTAT P2O, manu- |
| | factured by Ciba Specialty Chemicals) |
| | Tm: 180° C. |
| Additive 2 | Sulfonate (trade name: Ftergent 100: |
| | manufactured by NEOS Co. , Ltd) |
| Additive 3 | Carbon black pigment (trade name: |
| | MA100: manufactured by Mitsubishi |
| | Chemical Corporation) |

### Example 1

A twin-screw extruder (trade name: TEX30α; manufactured by The Japan Steel Works, LTD.) was used, and thermally melting and kneading were performed with the blend shown in Table 5 to prepare a resin composition. The thermally melting and kneading temperature was adjusted so as to fall within the range from 260° C. or more to 280° C. or less, and the thermally melting and kneading time was set to about 3 to 5 minutes.

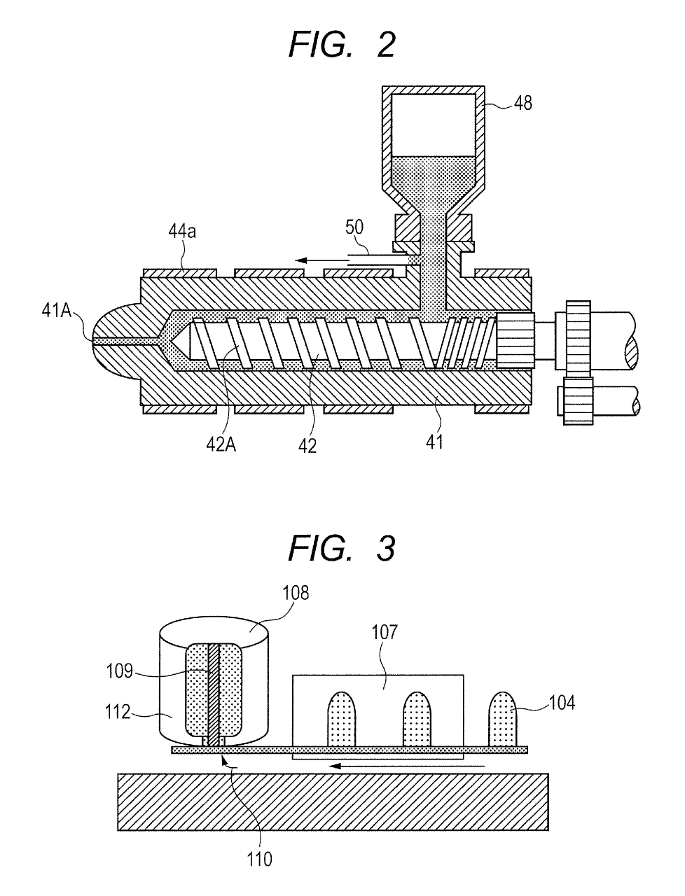

The resultant resin composition was pelletized, and the pellets were dried at a temperature of 140° C. for 6 hours. Next, a hopper 48 of an injection molding apparatus having a construction illustrated in FIG. 2 (trade name: SE180D, manufactured by Sumitomo Heavy Industries, Ltd.) was loaded with the dried resin composition in the form of pellets. Then, a cylinder set temperature was set to 295° C., and the resin composition was melted in a screw 42 and 42A. The molten resin composition was passed through a nozzle 41A and injection-molded into a mold to produce a preform 104. An injection molding mold temperature at this time was set to 30° C.

As illustrated in FIG. 3, the preform 104 was softened by being put into a heating apparatus 107 having a temperature of 500° C.

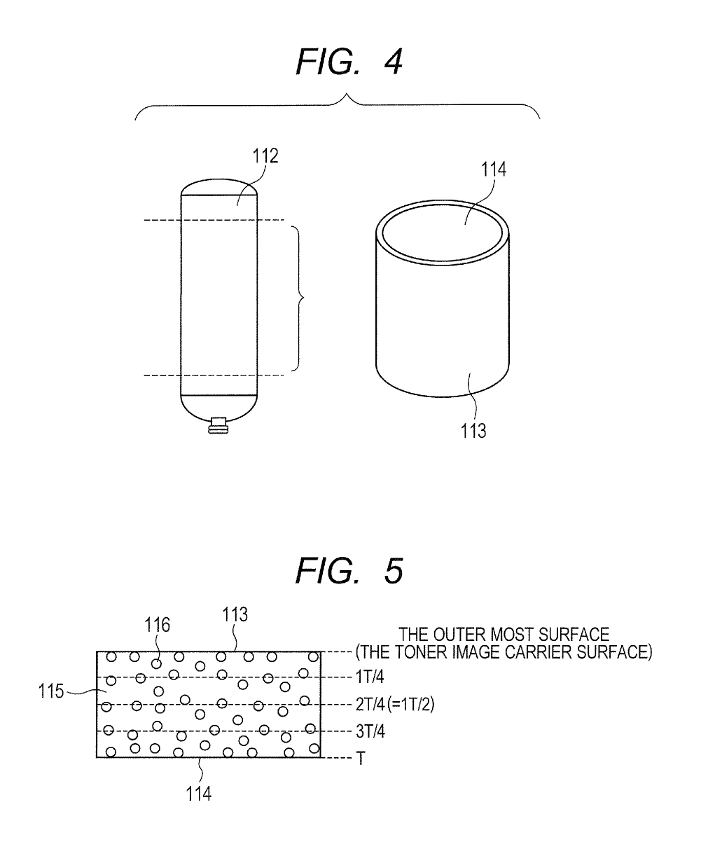

After that, the preform 104 was loaded into a primary blow molding machine illustrated in FIG. 3. Then, in a blow mold 108 kept at a mold temperature of 110° C., blow molding was performed with a stretching rod 109 and the force of air (blow air inlet 110) at a preform temperature of 155° C., an air pressure of 0.3 MPa, and a stretching rod speed of 1,000 mm/s to provide a blow-molded bottle 112. Both ends of the blow-molded bottle were cut off to provide an electrophotographic belt having an endless shape (FIG. 4). In FIG. 4, the blow-molded bottle is denoted by reference numeral 112, a belt outer surface is denoted by reference numeral 113, and a belt inner surface is denoted by reference numeral 114. The resultant electrophotographic belt had a width of 248 mm, a peripheral length of 715 mm, and a thickness of 80 μm. In addition, a sample piece measuring 20 mm in a circumferential direction and 100 mm in a width direction was cut out of part of the electrophotographic belt, and subjected to measurement with a tensile tester (INSTRON 5582 manufactured by INSTRON) at a tensile speed of 5 mm/min. As a result, its tensile modulus was found to be 2,100 MPa and its strength was also satisfactory. The electrophotographic belt was incorporated into the image forming apparatus illustrated in FIG. 1, and caused to undergo 100,000 rotations to be tested for its travelling property. As a result, there was no particular problem with no occurrence of puckering or bending. The evaluation results of this electrophotographic belt are shown in Table 6.

According to the results, the toner releasability (transfer efficiency %) was extremely satisfactory by maintaining a value of 90% or more through endurance use with a value of 93% at the initial stage, and a value of 91% even after the repeated use. In addition, by virtue of the contribution made by the blended silicone oil 1, the dispersibility of the polymer particles 1 was also satisfactory. The average primary particle diameter of the polymer particles 1 was 15.1 nm, and no large difference was found in surface roughness of the electrophotographic belt both at the initial stage and after the repeated use as compared to the surface roughness of the standard belt. In addition, the presence amount of silicone oil-derived silicon atoms at the outermost surface (toner image bearing surface) of the electrophotographic belt was 2.8 times as large as the presence amount of silicone oil-derived silicon atoms at the section at a depth of 1T/2 from the outermost surface.

### Example 2

An electrophotographic belt was obtained in the same manner as in Example 1 except that the blend of the resin composition was changed as shown in Table 5. The evaluation results of this electrophotographic belt are shown in Table 6.

According to the results, the toner releasability (transfer efficiency %) was extremely satisfactory by maintaining a value of 90% or more through endurance use with a value of 91% at the initial stage, and a value of 90% even after the repeated use. In addition, by virtue of the contribution made by the blended silicone oil 1, the dispersibility of the polymer particles 1 was also satisfactory. The average primary particle diameter of the polymer particles 1 was 12.4 nm, and no large difference was found in surface roughness of the electrophotographic belt both at the initial stage and after the repeated use as compared to the surface roughness of the standard belt. The presence amount ratio of silicone oil-derived silicon atoms between the surface of the belt and the 1T/2 section was 4.7 times.

### Example 3

An electrophotographic belt was obtained in the same manner as in Example 1 except that the blend of the resin composition was changed as shown in Table 5. The evaluation results of this electrophotographic belt are shown in Table 6.

According to the results, the toner releasability (transfer efficiency %) was extremely satisfactory by maintaining a value of 90% or more through endurance use with a value of 94% at the initial stage, and a value of 92% even after the repeated use. In addition, by virtue of the contribution made by the blended silicone oil 1, the dispersibility of the polymer particles 1 was also satisfactory. Aggregated particles were slightly observed, but the average primary particle diameter of the particles was 20.9 nm, and no large difference was found in surface roughness of the electrophotographic belt both at the initial stage and after the repeated use as compared to the surface roughness of the standard belt. The presence amount ratio of silicone oil-derived silicon atoms between the surface of the belt and the 1T/2 section was 1.4 times.

### Example 4

An electrophotographic belt was obtained in the same manner as in Example 1 except that the blend of the resin composition was changed as shown in Table 5. The evaluation results of this electrophotographic belt are shown in Table 6.

According to the results, the toner releasability (transfer efficiency %) was extremely satisfactory by maintaining a value of 90% or more through endurance use with a value of 94% at the initial stage, and a value of 93% even after the repeated use. In addition, by virtue of the contribution made by the blended silicone oil 2, the dispersibility of the polymer particles 1 was also satisfactory. Aggregated particles were slightly observed, but the average primary particle diameter of the particles was 28.3 nm, and no large difference was found in surface roughness of the electrophotographic belt both at the initial stage and after the repeated use as compared to the surface roughness of the standard belt. The presence amount ratio of silicone oil-derived silicon atoms between the surface of the belt and the 1T/2 section was 2.1 times.

### Example 5

An electrophotographic belt was obtained in the same manner as in Example 1 except that the blend of the resin composition was changed as shown in Table 5. The evaluation results of this electrophotographic belt are shown in Table 6.

According to the results, the toner releasability (transfer efficiency %) was extremely satisfactory by maintaining a value of 90% or more through endurance use with a value of 92% at the initial stage, and a value of 92% even after the repeated use. In addition, by virtue of the contribution made by the blended silicone oil 3, the dispersibility of the polymer particles 1 was also satisfactory. The average primary particle diameter of the polymer particles 1 was 16.5 nm, and no large difference was found in surface roughness of the electrophotographic belt both at the initial stage and after the repeated use as compared to the surface roughness of the standard belt. The presence amount ratio of silicone oil-derived silicon atoms between the surface of the belt and the 1T/2 section was 3.2 times.

### Example 6

An electrophotographic belt was obtained in the same manner as in Example 1 except that the blend of the resin composition was changed as shown in Table 5. The evaluation results of this electrophotographic belt are shown in Table 6.

According to the results, the toner releasability (transfer efficiency %) was extremely satisfactory by maintaining a value of 90% or more through endurance use with a value of 93% at the initial stage, and a value of 91% even after the repeated use. In addition, by virtue of the contribution made by the blended silicone oil 1, the dispersibility of the polymer particles 2 was also satisfactory. The polymer particles 2 had an extremely small average primary particle diameter of 3.4 nm, and no large difference was found in surface roughness of the electrophotographic belt both at the initial stage and after the repeated use as compared to the surface roughness of the standard belt. The presence amount ratio of silicone oil-derived silicon atoms between the surface of the belt and the 1T/2 section was 2.9 times.

### Example 7

An electrophotographic belt was obtained in the same manner as in Example 1 except that the blend of the resin composition was changed as shown in Table 5. The evaluation results of this electrophotographic belt are shown in Table 6.

According to the results, the toner releasability (transfer efficiency %) was extremely satisfactory by maintaining a value of 90% or more through endurance use with a value of 92% at the initial stage, and a value of 92% even after the repeated use. In addition, by virtue of the contribution made by the blended silicone oil 2, the dispersibility of the polymer particles 2 was also satisfactory. The average primary particle diameter of the polymer particles 2 was 7.9 nm, and no large difference was found in surface roughness of the electrophotographic belt both at the initial stage and after the repeated use as compared to the surface roughness of the standard belt. The presence amount ratio of silicone oil-derived silicon atoms between the surface of the belt and the 1T/2 section was 4.1 times.

### Example 8

An electrophotographic belt was obtained in the same manner as in Example 1 except that the blend of the resin composition was changed as shown in Table 5. The evaluation results of this electrophotographic belt are shown in Table 6.

According to the results, the toner releasability (transfer efficiency %) was extremely satisfactory by maintaining a value of 90% or more through endurance use with a value of 92% at the initial stage, and a value of 90% even after the repeated use. In addition, by virtue of the contribution made by the blended silicone oil 3, the dispersibility of the polymer particles 2 was also satisfactory. The average primary particle diameter of the polymer particles 2 was 5.8 nm, and no large difference was found in surface roughness of the electrophotographic belt both at the initial stage and after the repeated use as compared to the surface roughness of the standard belt. The presence amount ratio of silicone oil-derived silicon atoms between the surface of the belt and the 1T/2 section was 3.8 times.

### Example 9

An electrophotographic belt was obtained in the same manner as in Example 1 except that the blend of the resin composition was changed as shown in Table 5. The evaluation results of this electrophotographic belt are shown in Table 6.

According to the results, the toner releasability (transfer efficiency %) was extremely satisfactory by maintaining a value of 90% or more through endurance use with a value of 94% at the initial stage, and a value of 91% even after the repeated use. In addition, by virtue of the contribution made by the blended silicone oil 4, the dispersibility of the polymer particles 2 was also satisfactory. The average primary particle diameter of the polymer particles 2 was 9.6 nm, and no large difference was found in surface roughness of the electrophotographic belt both at the initial stage and after the repeated use as compared to the surface roughness of the standard belt. The presence amount ratio of silicone oil-derived silicon atoms between the surface of the belt and the 1T/2 section was 1.6 times.

### Example 10

An electrophotographic belt was obtained in the same manner as in Example 1 except that the blend of the resin composition was changed as shown in Table 5. The evaluation results of this electrophotographic belt are shown in Table 6.

According to the results, the toner releasability (transfer efficiency %) was extremely satisfactory by maintaining a value of 90% or more through endurance use with a value of 92% at the initial stage, and a value of 91% even after the repeated use. In addition, by virtue of the contribution made by the blended silicone oil 1, the dispersibility of the polymer particles 1 was also satisfactory. The average primary particle diameter of the polymer particles 1 was 11.2 nm, and no large difference was found in surface roughness of the electrophotographic belt both at the initial stage and after the repeated use as compared to the surface roughness of the standard belt. The presence amount ratio of silicone oil-derived silicon atoms between the surface of the belt and the 1T/2 section was 2.6 times.

### Example 11

An electrophotographic belt was obtained in the same manner as in Example 1 except that the blend of the resin composition was changed as shown in Table 5. The evaluation results of this electrophotographic belt are shown in Table 6.

According to the results, the toner releasability (transfer efficiency %) was extremely satisfactory by maintaining a value of 90% or more through endurance use with a value of 93% at the initial stage, and a value of 92% even after the repeated use. In addition, by virtue of the contribution made by the blended silicone oil 1, the dispersibility of the polymer particles 1 was also satisfactory. Aggregated particles were slightly observed, but the average primary particle diameter of the particles was 21.6 nm, and no large difference was found in surface roughness of the electrophotographic belt both at the initial stage and after the repeated use as compared to the surface roughness of the standard belt. The presence amount ratio of silicone oil-derived silicon atoms between the surface of the belt and the 1T/2 section was 2.5 times.

### Example 12

An electrophotographic belt was obtained in the same manner as in Example 1 except that the blend of the resin composition was changed as shown in Table 5. The evaluation results of this electrophotographic belt are shown in Table 6.

According to the results, the toner releasability (transfer efficiency %) was extremely satisfactory by maintaining a value of 90% or more through endurance use with a value of 91% at the initial stage, and a value of 91% even after the repeated use. In addition, by virtue of the contribution made by the blended silicone oil 1, the dispersibility of the polymer particles 2 was also satisfactory. The polymer particles 2 had an extremely small average primary particle diameter of 4.8 nm, and no large difference was found in surface roughness of the electrophotographic belt both at the initial stage and after the repeated use as compared to the surface roughness of the standard belt. The presence amount ratio of silicone oil-derived silicon atoms between the surface of the belt and the 1T/2 section was 2.7 times.

TABLE 5

| Example | 1 | 2 | 3 | 4 | 5 | 6 | 7 | 8 | 9 | 10 | 11 | 12 |
|---|---|---|---|---|---|---|---|---|---|---|---|---|
| Thermoplastic resin 1 | 80.0 | 81.2 | 74.0 | 74.0 | 80.0 | 79.0 | 80.0 | 80.0 | 77.0 | — | — | — |
| Thermoplastic resin 2 | — | — | — | — | — | — | — | — | — | 80.0 | 78.0 | 80.0 |
| Polymer particles 1 | 1.0 | 0.3 | 3.0 | 5.0 | 1.0 | — | — | — | — | 1.0 | 3.0 | — |
| Polymer particles 2 | — | — | — | — | — | 1.0 | 1.0 | 1.0 | 3.0 | — | — | 1.0 |
| Polymer particles 3 | — | — | — | — | — | — | — | — | — | — | — | — |
| Silicone oil 1 | 1.0 | 0.5 | 5.0 | | — | 2.0 | — | — | — | 1.0 | 1.0 | 1.0 |
| Silicone oil 2 | — | — | — | 3.0 | — | — | 1.0 | — | — | — | — | — |
| Silicone oil 3 | — | — | — | — | 1.0 | — | | 1.0 | — | — | — | — |
| Silicone oil 4 | — | — | — | — | — | — | — | — | 2.0 | — | — | — |
| Additive 1 | 15.0 | 15.0 | 15.0 | 15.0 | 15.0 | 15.0 | 15.0 | 15.0 | 15.0 | 15.0 | 15.0 | 15.0 |
| Additive 2 | 2.0 | 2.0 | 2.0 | 2.0 | 2.0 | 2.0 | 2.0 | 2.0 | 2.0 | 2.0 | 2.0 | 2.0 |
| Additive 3 | 1.0 | 1.0 | 1.0 | 1.0 | 1.0 | 1.0 | 1.0 | 1.0 | 1.0 | 1.0 | 1.0 | 1.0 |

Unit: part(s) by mass

Evaluation items (1) to (5) in Table 6 are as described below.

Evaluation item (1): toner releasability (transfer efficiency %) of outermost surface at initial stage and that after repeated use
Evaluation item (2): surface roughness Rzjis (μm) of outermost surface at initial stage and that after repeated use
Evaluation item (3): average particle diameter (nm) of polymer particles each having fluorinated hydrocarbon group
Evaluation item (4): dispersibility of polymer particles each having fluorinated hydrocarbon group
Evaluation item (5): presence amount ratio (times) of silicone oil-derived silicon atoms=[presence amount of silicone oil-derived silicon atoms at outermost surface (toner image bearing surface) of electrophotographic belt]/[presence amount of silicone oil-derived silicon atoms at section at depth of 1T/2 from outermost surface]

TABLE 6

| | | Exam- | Exam- | Exam- | Exam- | Exam- | Exam- | Exam- | Exam- | Exam- | Exam- | Exam- | Exam- |
|---|---|---|---|---|---|---|---|---|---|---|---|---|---|
| Evaluation item | | ple 1 | ple 2 | ple 3 | ple 4 | ple 5 | ple 6 | ple 7 | ple 8 | ple 9 | ple 10 | ple 11 | ple 12 |
| (1) | Initial stage | 93 | 91 | 94 | 94 | 92 | 93 | 92 | 92 | 94 | 92 | 93 | 91 |
| | After repeated use | 91 | 90 | 92 | 93 | 92 | 91 | 92 | 90 | 91 | 91 | 92 | 91 |
| (2) | Initial stage | 0.21 | 0.24 | 0.19 | 0.23 | 0.23 | 0.22 | 0.20 | 0.21 | 0.24 | 0.20 | 0.19 | 0.21 |
| | After repeated use | 0.25 | 0.27 | 0.24 | 0.25 | 0.26 | 0.27 | 0.24 | 0.25 | 0.28 | 0.23 | 0.22 | 0.23 |

| | | | | | | | | | | | | |
|---|---|---|---|---|---|---|---|---|---|---|---|---|
| (3) | 15.1 | 12.4 | 20.9 | 28.3 | 16.5 | 3.4 | 7.9 | 5.8 | 9.6 | 11.2 | 21.6 | 4.8 |
| (4) | A | A | A | A | A | A | A | A | A | A | A | A |
| (5) | 2.8 | 4.7 | 1.4 | 2.1 | 3.2 | 2.9 | 4.1 | 3.8 | 1.6 | 2.6 | 2.5 | 2.7 |

### Comparative Example 1

An electrophotographic belt was obtained in the same manner as in Example 1 except that the blend of the resin composition was changed as shown in Table 7. The evaluation results of this electrophotographic belt are shown in Table 8.

According to the results, the toner releasability (transfer efficiency %) was extremely satisfactory with a value of 94% at the initial stage, but was reduced to 81% after the repeated use. This may be due to poor dispersibility of the polymer particles 1 resulting from the absence of any silicone oil blended. A cross-section of the electrophotographic belt in the thickness direction at the initial stage was subjected to TEM observation. As a result, it was confirmed that the polymer particles 1 were remarkably localized to the vicinity of the surface of the belt. Therefore, the toner releasability was reduced probably because the number of the polymer particles 1 became remarkably decreased when the surface of the electrophotographic belt was worn away through repeated use.

The polymer particles 1 had an extremely small average primary particle diameter of 11.5 nm, and no large difference was found in surface roughness of the electrophotographic belt both at the initial stage and after the repeated use as compared to the surface roughness of the standard belt.

### Comparative Example 2

An electrophotographic belt was obtained in the same manner as in Example 1 except that the blend of the resin composition was changed as shown in Table 7. The evaluation results of this electrophotographic belt are shown in Table 8.

According to the results, the toner releasability (transfer efficiency %) was extremely satisfactory with a value of 95% at the initial stage, but was reduced to 83% after the repeated use. The toner releasability was reduced probably for the same reason as that in Comparative Example 1.

The average primary particle diameter of the polymer particles 1 was 19.4 nm, and no large difference was found in surface roughness of the electrophotographic belt both at the initial stage and after the repeated use as compared to the surface roughness of the standard belt.

### Comparative Example 3

An electrophotographic belt was obtained in the same manner as in Example 1 except that the blend of the resin composition was changed as shown in Table 7. The evaluation results of this electrophotographic belt are shown in Table 8.

According to the results, the toner releasability (transfer efficiency %) was less than 90% both at the initial stage and after the repeated use. The toner releasability was degraded probably because the blended polymer particles 3 had an extremely large average primary particle diameter of 186.2 nm and the surface smoothness was reduced as compared to the standard belt.

In addition, although the silicone oil was not blended, the polymer particles had large particle diameters, and hence, at the time of heat treatment in belt molding, were probably not able to move easily in the thermoplastic matrix resin, with the result that their dispersion state was maintained.

### Comparative Example 4

An electrophotographic belt was obtained in the same manner as in Example 1 except that the blend of the resin composition was changed as shown in Table 7. The evaluation results of this electrophotographic belt are shown in Table 8.

According to the results, the toner releasability (transfer efficiency %) was less than 90% both at the initial stage and after the repeated use. The toner releasability was degraded probably because as in Comparative Example 3, the blended polymer particles 3 had an extremely large average primary particle diameter of 234.9 nm and the surface smoothness was reduced as compared to the standard belt.

In addition, as in Comparative Example 3, the dispersibility of the polymer particles 3 was satisfactory, and no improvement in toner releasability by virtue of the blending of the silicone oil was able to be found. The presence amount ratio of silicone oil-derived silicon atoms between the surface of the belt and the 1T/2 section was 3.2 times.

TABLE 7

| Comparative Example | 1 | 2 | 3 | 4 |
|---|---|---|---|---|
| Thermoplastic resin 1 | 80.0 | 81.0 | 81.0 | 80.0 |
| Thermoplastic resin 2 | — | — | — | — |
| Polymer particles 1 | 1.0 | 6.0 | — | — |
| Polymer particles 2 | — | — | — | — |
| Polymer particles 3 | — | — | 1.0 | 1.0 |
| Silicone oil 1 | — | — | — | 1.0 |
| Silicone oil 2 | — | — | — | — |
| Silicone oil 3 | — | — | — | — |
| Silicone oil 4 | — | — | — | — |
| Additive 1 | 15.0 | 15.0 | 15.0 | 15.0 |
| Additive 2 | 2.0 | 2.0 | 2.0 | 2.0 |
| Additive 3 | 1.0 | 1.0 | 1.0 | 1.0 |

Unit: part(s) by mass

Evaluation items (1) to (5) in Table 8 are the same as the evaluation items (1) to (5) in Table 6.

TABLE 8

| Evaluation | | Comparative | Comparative | Comparative | Comparative |
|---|---|---|---|---|---|
| item | | Example 1 | Example 2 | Example 3 | Example 4 |
| (1) | Initial | 94 | 95 | 87 | 88 |
| | stage | | | | |
| | Endurance | 81 | 83 | 85 | 86 |
| (2) | Initial | 0.19 | 0.21 | 0.49 | 0.45 |
| | stage | | | | |
| | Endurance | 0.24 | 0.23 | 0.66 | 0.63 |
| (3) | | 11.5 | 19.4 | 186.2 | 234.9 |
| (4) | | C | C | A | A |
| (5) | | — | — | — | 3.2 |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-128298, filed Jun. 23, 2014, which is hereby incorporated by reference herein in its entirety.

What is claimed is:

1. An electrophotographic mono-layer belt, comprising:
a particle containing a polymer having a fluorinated hydrocarbon group; and
a silicone oil,
the particle and the silicone oil being in a thermoplastic matrix resin,
wherein:
the particle has an average primary particle diameter of from 3 nm to 30 nm, and
the polymer comprises a branched polymer that has a functional group represented by the following formula [1] at a terminal of a side chain;
when a thickness of the electrophotographic mono-layer belt is represented by T, in a cross-section of the electrophotographic mono-layer belt in a thickness direction, a presence amount of silicon atom derived from the silicone oil at a surface of the belt satisfies a relationship of (presence amount of a silicon atom at surface of belt)>(presence amount of a silicon atom at 1T/2-thickness section); and
the particle is dispersed in the belt in the thickness direction: 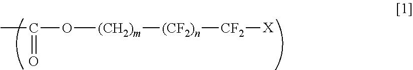
where X represents a hydrogen atom or a fluorine atom, m represents 1 or 2, and n represents an integer of from 0 to 5.

2. An electrophotographic belt according to claim 1, wherein the presence amount of a silicon atom derived from the silicone oil at the surface of the belt satisfies a relationship of (presence amount of a silicon atom at surface of belt)≧1.4×(presence amount of a silicon atom at 1T/2-thickness section).

3. An electrophotographic belt according to claim 1, wherein:
the thermoplastic matrix resin comprises a thermoplastic polyester resin; and
the silicone oil comprises a dimethyl silicone oil.

4. An electrophotographic belt according to claim 1, wherein a content of the particle is 0.3 mass % or more and 5.0 mass % or less with respect to a total mass of the electrophotographic mono-layer belt.

5. An electrophotographic belt according to claim 1, wherein a content of the silicone oil is 0.5 mass % or more and 5.0 mass % or less with respect to a total mass of the electrophotographic mono-layer belt.

6. An electrophotographic belt according to claim 1, wherein a content of the thermoplastic matrix resin is 50.0 mass % or more and 99.2 mass % or less with respect to a total mass of the electrophotographic mono-layer belt.

7. An electrophotographic image forming apparatus, comprising:
an electrostatic latent image bearing member;
an intermediate transfer device;
a unit configured to primarily transfer a toner image borne on the electrostatic latent image bearing member onto the intermediate transfer device;
a unit configured to secondarily transfer the toner image, which is primarily transferred onto the intermediate transfer device, from the intermediate transfer device onto a recording medium; and
a fixing apparatus configured to fix the toner image secondarily transferred onto the recording medium,
wherein the intermediate transfer device comprises the electrophotographic mono-layer belt of claim 1.
